(19) United States
(12) Patent Application Publication
(10) Pub. No.: US 2010/0110911 A1
(43) Pub. Date: May 6, 2010

(54) Method and system for conserving power in powerline network having multiple logical networks

(76) Inventor: Zhanping Yin, Vancouver, WA (US)

Correspondence Address: SHARP LABORATORIES OF AMERICA, INC., 1320 PEARL ST., SUITE 228, BOULDER, CO, 80302, US

(21) Appl. No.: 12/290,949

(22) Filed: Nov. 5, 2008

(51) Int. Cl. H04L 12/26

(52) U.S. Cl. 370/252

(57) ABSTRACT

A method and system for conserving power in a powerline network, such as a Homeplug AV (HPAV) network, that has multiple logical networks, such as multiple AV logical networks (AVLN). Power conservation is achieved through the expedient of a packet presence region (PPR) that informs nodes whether or not they need to monitor a shared carrier sense multiple access (CSMA) region in a particular beacon period.

### BACKGROUND OF THE INVENTION

The present invention relates to powerline networking and, more particularly, to a method and system for conserving power in a powerline network having multiple logical networks.

Powerline networks provide entertainment-oriented networking by supporting communication of video, audio and data content over alternating current (AC) wiring within dwelling units, including multiple dwelling units (MDU) such as condominium and apartment complexes. One industry specification that defines current generation powerline networks is HomePlug AV (HPAV). An HPAV network in an MDU, while operating on a single physical channel, is often segmented into multiple audiovisual logical networks (AVLN), e.g. one AVLN per dwelling unit, to ensure data privacy. Each AVLN in the multiple AVLN HPAV network has one or more nodes and is managed by a central coordinator (CCo) entity that is active on a managing one of the nodes. Each AVLN is assigned a different network membership key (NMK) that enables nodes within the AVLN to encrypt and decrypt information transmitted within the AVLN and prevents nodes outside the AVLN from interpreting such information.

Communication in a multiple AVLN HPAV network is achieved by transmitting and receiving information on the channel in successive beacon periods pursuant to a transmission schedule negotiated by the managing nodes of the various AVLN. The beacon periods are synchronized to the AC line cycle with each beacon period traversing two cycles. Turning to FIG. 1, within a beacon period 100 there is a beacon region 110, a shared carrier sense multiple access (CSMA) region 120 and, in some implementations, a reserved region 130. The managing nodes of the various AVLN negotiate beacon slots 140, 150 within beacon region 110 for advertising information (e.g. transmission schedules) to the nodes within their respective AVLN. Beacon region 110 is followed by a mandatory shared CSMA region 120 in which all nodes may attempt contention-based communication on a priority or “best effort” basis. Shared CSMA region 120 is followed, in some implementations, by reserved region 130 in which nodes that have been allocated time slots by their respective managing nodes may engage in contention-free communication. In some implementations, the beacon period does not include a reserved region.

In known implementations of multiple AVLN HPAV networks, all nodes monitor the channel in the shared CSMA region of each beacon period and, in the shared CSMA region, participate in priority resolution, capture all packets, interpret frame control (FC) in all packets, determine whether they are an intended destination for all packets and discard packets for which they are not an intended destination. Naturally, all packets belonging to other AVLN are discarded. Having all nodes monitor the shared CSMA region can, however, waste considerable power. It may be the case that in a particular shared CSMA region a particular AVLN does not have any node with a packet to transmit. Indeed, it may be the case that in a particular shared CSMA region no AVLN has any node with a packet to transmit. In these situations, having all nodes monitor the shared CSMA region consumes power on monitoring tasks that are superfluous.

### SUMMARY OF THE INVENTION

The present invention, in a basic feature, provides a method and system for conserving power in a powerline network, such as an HPAV network, that has multiple logical networks, such as multiple AVLN. Power conservation is achieved through the expedient of a packet presence region (PPR) that informs nodes whether or not they need to monitor in a shared CSMA region in a particular beacon period.

In one aspect of the invention, a method performed by a managed node in a powerline network having multiple logical networks comprises the steps of monitoring for a packet presence symbol (PPS) in a PPR of a beacon period and regulating monitoring of a shared CSMA region of the beacon period by the managed node based on whether the PPS is detected.

In some embodiments, the PPR is part of an extended beacon region that precedes the shared CSMA region.

In some embodiments, the monitoring step comprises monitoring for the PPS in a PPS slot assigned to a logical network to which the managed node belongs.

In some embodiments, the method further comprises the step of detecting a PPR presence indicator (PPI) in a beacon region of the beacon period prior to the monitoring step.

In some embodiments, the detecting step comprises detecting the PPI in a beacon slot assigned to a logical network to which the managed node belongs.

In some embodiments, the method further comprises the step of transmitting the PPS in the PPR.

In some embodiments, the regulating monitoring step comprises monitoring the shared CSMA region by the managed node in response to detecting the PPS.

In some embodiments, the regulating monitoring step comprises inhibiting monitoring of the shared CSMA region by the managed node in response to failing to detect the PPS.

In some embodiments, the method is individually performed by a plurality of managed nodes that belong to a common logical network.

In another aspect of the invention, a method performed by a managing node in a powerline network having multiple logical networks comprises the steps of monitoring for a PPS in a plurality of PPS slots assigned to a respective plurality of logical networks in a PPR of a beacon period and regulating monitoring of a shared CSMA region of the beacon period by the managing node based on whether the PPS is detected in at least one of the PPS slots.

In some embodiments, the method further comprises the step of transmitting a PPI in a beacon region of the beacon period prior to the monitoring step.

In some embodiments, the transmitting step comprises transmitting the PPI in a beacon slot assigned to a logical network to which the managing node belongs.

In some embodiments, the method further comprises the step of transmitting the PPS in a PPS slot assigned to a logical network to which the managing node belongs.

In some embodiments, the regulating monitoring step comprises monitoring the shared CSMA region by the managing node in response to detecting the PPS in at least one of the PPS slots.

In some embodiments, the regulating monitoring step comprises inhibiting monitoring of the shared CSMA region by the managing node in response to failing to detect the PPS within any of the PPS slots.

In some embodiments, inhibiting monitoring of the shared CSMA region comprises eliminating the shared CSMA region.

In some embodiments, the method is individually performed by a plurality of managing nodes that belong to a respective plurality of logical networks.

In yet another aspect of the invention, a powerline network comprises a managing node that belongs to a logical network, a managed node that belongs to the logical network and a channel that communicatively couples the managing node and the managed node, wherein the managed node monitors for a PPS in a PPS slot assigned to the logical network in a PPR of a beacon period and regulates monitoring of a shared CSMA region of the beacon period by the managed node based on whether the PPS is detected, and wherein the managing node monitors for the PPS in a plurality of PPS slots assigned to a respective plurality of logical networks in the PPR and regulates monitoring of the shared CSMA region by the managing node based on whether the PPS is detected in at least one of the PPS slots.

In some embodiments, the managing node transmits a PPI in a beacon region of the beacon period and the managed node detects the PPI.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a beacon period of a known multiple AVLN HPAV network.

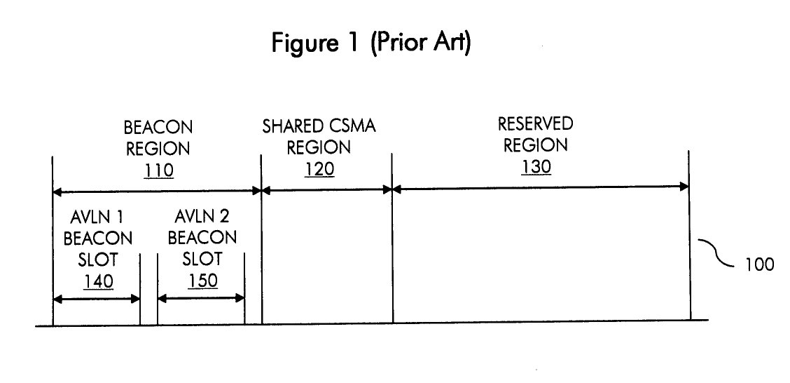

FIG. 2 shows a multiple AVLN HPAV network in some embodiments of the invention.

FIG. 3 shows a beacon period of a multiple AVLN HPAV network in some embodiments of the invention.

FIG. 4 shows a beacon period of a multiple AVLN HPAV network in other embodiments of the invention.

FIG. 5 shows a method performed by a managing node in a multiple AVLN HPAV network in some embodiments of the invention.

FIG. 6 shows a method performed by a managed node in a multiple AVLN HPAV network in some embodiments of the invention.

### DETAILED DESCRIPTION OF A PREFERRED EMBODIMENT

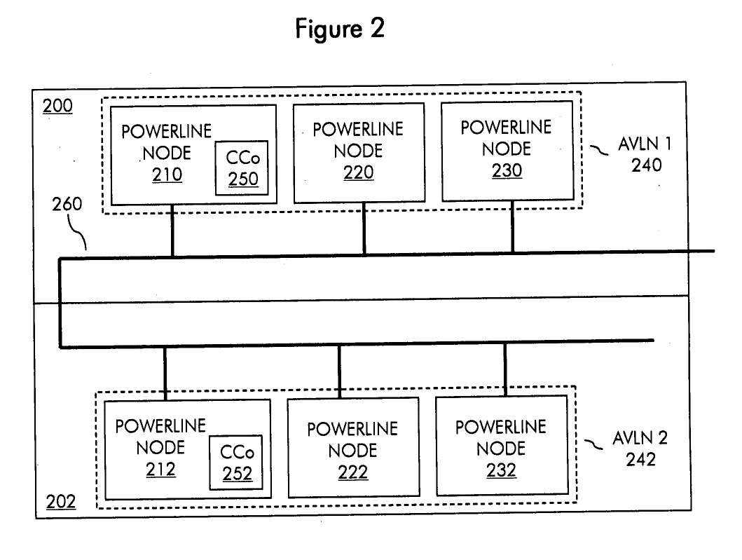

FIG. 2 shows a multiple AVLN HPAV network in some embodiments of the invention. The network is operative in an MDU, such as a condominium complex or an apartment complex, and spans dwelling units 200, 202. Dwelling unit 200 includes powerline nodes 210, 220, 230 that are members of a first AVLN (AVLN 1) 240. Nodes 210, 220, 230 include a managing node 210 that has been designated CCo and has an active CCo entity 250 and managed nodes 220, 230. Dwelling unit 202 includes powerline nodes 212, 222, 232 that belong to a second AVLN (AVLN 2) 242. Nodes 212, 222, 232 include a managing node 212 that has been designated CCo and has an active CCo entity 252 and managed nodes 222, 232. All nodes 210, 220, 230, 212, 222, 232 are connected to an AC power line 260 that provides a channel for communication of video, audio and data content and control information in beacon periods that are synchronized to the AC line cycle, with each beacon period traversing two AC line cycles. Nodes 210, 220, 230, 212, 222, 232 may include, by way of example, televisions, stereos, powered speakers, receivers, digital video disc (DVD) players, compact disc (CD) players, digital picture frames, home intercom systems, routers, switches, gateways, bridges, network attached storage, surveillance cameras, voice over Internet Protocol (VoIP) phones, personal computers (PC) and personal data assistants (PDA) that are HPAV compatible. Naturally, the number of nodes and AVLN is illustrative and may vary. Moreover, while a multiple AVLN HPAV network is described, the invention may have application in other types of powerline networks that have multiple logical networks.

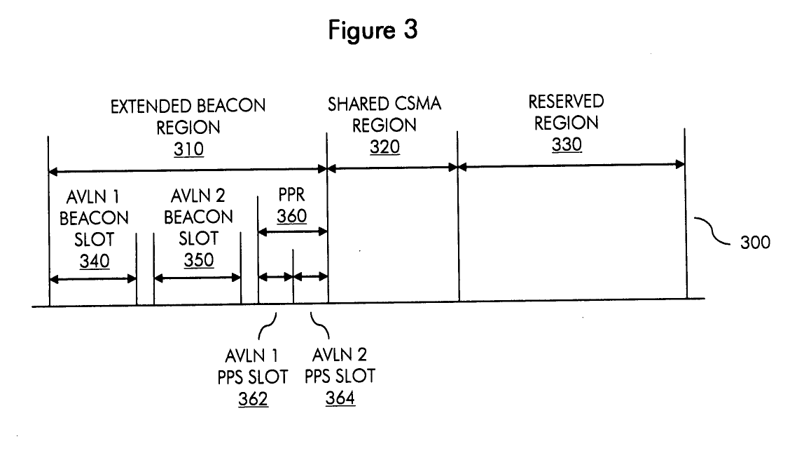

FIG. 3 shows a beacon period 300 of a multiple AVLN HPAV network in some embodiments of the invention. Beacon period 300 includes an extended beacon region 310 followed by a shared CSMA region 320 and a reserved region 330. Extended beacon region 310 has a beacon slot 340 assigned to AVLN 1 240 and a beacon slot 350 assigned to AVLN 2 242. Beacon slots 340, 350 are negotiated by CCo entities 250, 252 and are used by CCo entities 250, 252 to convey control information, such as PPI, PPS slot definitions and scheduling information. Nodes 210, 220, 230 that belong to AVLN 1 240 monitor beacon slot 340, whereas nodes 212, 222, 232 that belong to AVLN 2 242 monitor beacon slot 350.

Beacon slots 340, 350 inform nodes 210, 220, 230, 212, 222, 232 as to the presence or absence of a PPR and, if a PPR is present, the length of the PPR and the length and position of PPS slots assigned to AVLNs within the PPR. For the multiple AVLN HPAV network of FIG. 2, for example, there is a PPR 330 having a first PPS slot 362 assigned to AVLAN 1 240 and a second PPS slot 364 assigned to AVLN 2 242, which PPS slots 362, 364 are defined in beacon slots 340, 350, respectively. In some embodiments, beacon slots 340, 350 each have a preamble, a FC and a beacon payload. Within each beacon payload, at octet eleven bits four through seven, there is a reserved four-bit region wherein bit six is a PPI bit that indicates the presence or absence of a PPR. In some embodiments, a PPI bit is set to a value of “1” to provide a PPI indicative of the presence of a PPR and is set to “0” to indicate the absence of a PPR. Where presence of a PPR is indicated, beacon slots 340, 350 further inform as to the length of the PPR and the length and position of PPS slots assigned to AVLN within the PPR via PPS slot definitions provided in NumSlots, SlotUsage and SlotID fields. Generally speaking, AVLN are assigned PPS slots in the same order as beacon slots 340, 350. PPR is mode optional in beacon period 300 because the desirability of using PPR may vary depending on network configuration and requirements. For example, in the multiple AVLN HPAV network shown in FIG. 2 where there are two active AVLN, it may be preferable to have a PPR so that managed nodes 220, 230, 222, 232 only monitor shared CSMA region 320 in beacon periods when a node within their respective AVLN has a packet to transmit in shared CSMA region 320. On the other hand, in a different network configuration where there is only one active AVLN, it may be preferable to exclude a PPR and have all nodes monitor the shared CSMA region in every beacon period.

Following beacon slots 340, 350 within extended beacon region 310 is PPR 360. PPR 360 informs managed nodes 220, 230, 222, 232 whether a node within their respective AVLN has a packet to transmit in shared CSMA region 320, and informs managing nodes 210, 220 whether a node within any AVLN has a packet to transmit in shared CDMA region 320. PPR 360 thus instructs nodes 210, 220, 230, 212, 222, 232 whether or not they need to monitor shared CSMA region 320 in the current beacon period. If one or more of nodes 210, 220, 230 within AVLN 1 240 has a packet to send in shared CSMA region 320, the one or more of nodes 210, 220, 230 transmits a PPS in PPS slot 362 allocated to AVLAN 1 240. Similarly, if one or more of nodes 212, 222, 232 within AVLN 2 242 has a packet to send in shared CSMA region 320, the one or more of nodes 212, 222, 232 transmits a PPS in PPS slot 364 allocated to AVLAN 2 242. In some embodiments, the format for a PPS a variant of the format for the HPAV priority resolution symbol (PRS). Meanwhile, the ones of nodes 210, 220, 230, 212, 222, 232 that do not have a packet to send monitor their respective PPS slots 362, 364 to detect any PPS sent by other nodes.

Following extended beacon region 310 is shared CSMA region 320. In shared CSMA region 320, each one of nodes 210, 220, 230, 212, 222, 232 that has a packet to send attempts contention-based communication of the packet on a priority or “best effort” basis. Also, each one of managed nodes 220, 230, 222, 232 that does not have a packet to send regulates its monitoring of AC powerline 260 in shared CSMA region 320 based on whether the managed node detected a PPS in the one of PPS slots 362, 364 for the one of AVLN 240, 242 to which the managed node belongs. For example, if managed node 220 does not have a packet to send and did not detect a PPS in PPS slot 362 for AVLN 1 240 to which managed node 220 belongs, managed node 220 does not monitor for packets in shared CSMA region 320. On the other hand, if managed node 220 does not have a packet to send but did detect a PPS in PPS slot 362 for AVLN 1 240 to which managed node 220 belongs, managed node 220 monitors for packets during shared CSMA region 320. Moreover, each one of managing nodes 210, 212 that does not have a packet to send regulates its monitoring of AC powerline 260 in shared CSMA region 230 based on whether the managing node detected a PPS in any of PPS slots 362, 364. For example, if managing node 210 does not have a packet to send and did not detect a PPS in either of PPS slots 362, 364, managing node 210 does not monitor in shared CSMA region 320. On the other hand, if managing node 210 does not have a packet to send but did detect a PPS in either PPS slot 362 for AVLN 1 240 or PPS slot 364 for AVLN 2 242, managing node 210 monitors in shared CSMA region 320. Managing nodes 210, 212 must monitor shared CSMA region 320 if a PPS is detected in any PPS slot because CCo entities 250, 252 must be available during shared CSMA region 320 to receive any packets transmitted by other CCo entities.

Following shared CSMA region 320 is reserved region 330. In reserved region 330, nodes 210, 220, 230, 212, 222, 232 that have been allocated time slots by their respective CCo entities 250, 252 during extended beacon region 310 engage in contention-free communication.

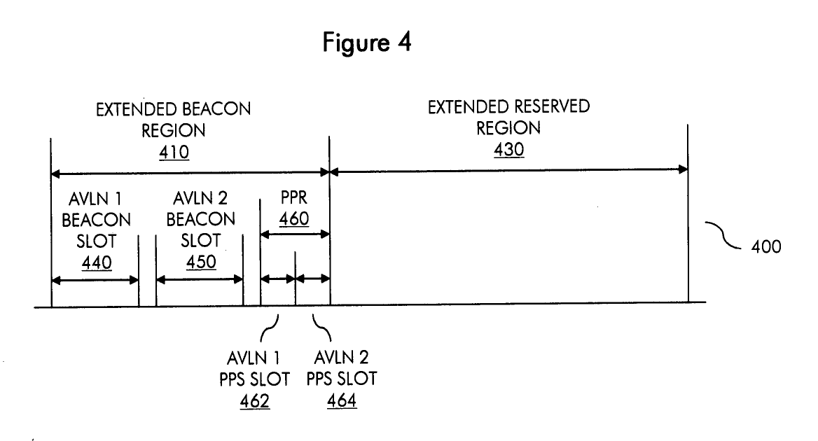

FIG. 4 shows a beacon period 400 of a multiple AVLN HPAV network in other embodiments of the invention. In these embodiments, extended beacon region 410, AVLN 1 beacon slot 440, AVLN 2 beacon slot 450, PPR 460, AVLN 1 PPS slot 462 and AVLN 2 PPS slot 464 serve the same purposes as their counterparts in FIG. 3. However, in these embodiments all nodes 210, 220, 230, 212, 222, 232 monitor all PPS slots 462, 464, and if no PPS is detected in any PPS slot, the shared CSMA region is eliminated and an extended reserved region 430 immediately follows extended beacon region 410.

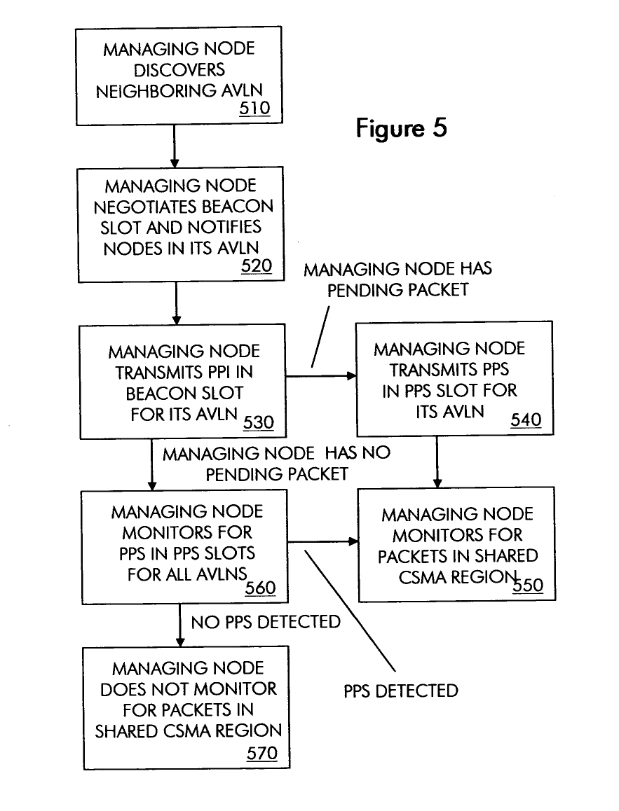

FIG. 5 shows a method performed in some embodiments by a managing node in a multiple AVLN HPAV network. A managing node is a node that is acting as CCo of an AVLN. In the method, the managing node discovers a neighboring AVLN (510). The managing node then negotiates a beacon slot and notifies the managed nodes in its AVLN of the beacon slot (520). The managing node then transmits a PPI in the beacon slot reserved for its AVLN indicating the presence of a PPR (530) and also indicates the length of the PPR and the length and position of the PPS slot assigned to the AVLN in the PPR. If the managing node has a packet to transmit in the shared CSMA region, the managing node transmits a PPS in the PPS slot assigned to the AVLN (540) and monitors for packets in the shared CSMA region (550), as well as transmitting its own pending packet. If the managing node does not have a packet to transmit in the shared CSMA region, the managing node monitors for a PPS in any PPS slot (560). If a PPS is detected in any PPS slot, the managing node monitors for packets in the shared CSMA region (550). If the managing node does not detect a PPS in any PPS slot, the managing node does not monitor for packets in the shared CSMA region (570).

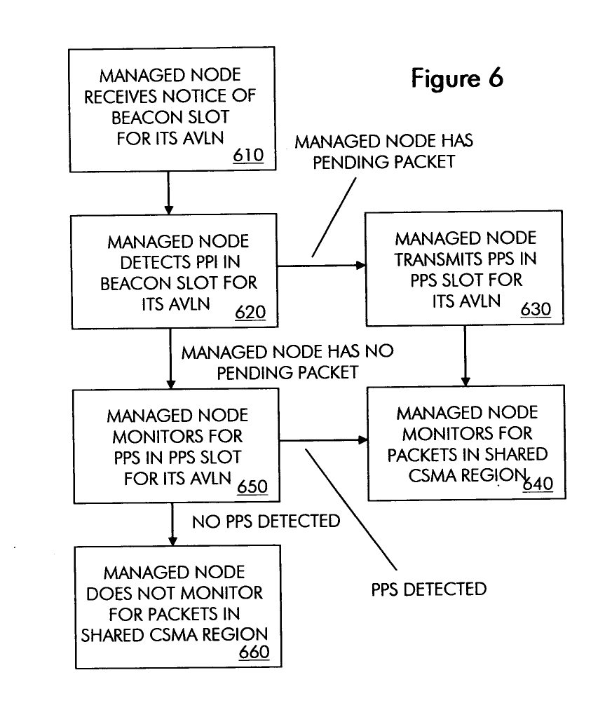

FIG. 6 shows a method performed in some embodiments by a managed node in a multiple AVLN HPAV network. A managed node is a node that is not acting as CCo of an AVLN. The managed node receives from the managing node of the AVLN notification of a beacon slot assigned to the AVLN (610). The managed node detects a PPI in the beacon slot assigned to its AVLN indicating the presence of a PPR (620) and an indication of the length of the PPR and the length and position of the PPS slot assigned to its AVLN within the PPR. If the managed node has a packet to transmit in the shared CSMA region, the managed node transmits a PPS in the PPS slot assigned to its AVLN (630) and monitors for packets in the shared CSMA region (640), as well as transmitting its own pending packet. If the managed node does not have a packet to transmit in the shared CSMA region, the managed node monitors for a PPS in the PPS slot assigned to its AVLN (650). If a PPS is detected in the PPS slot, the managed node monitors for packets in the shared CSMA region (640). If the managed node does not detect a PPS in the PPS slot, the managed node does not monitor for packets in the shared CSMA region (660).

In some embodiments, a multiple AVLN powerline network may be configured in which certain AVLN support an extended beacon period/PPR while others do not. In these hybrid network configurations, managing nodes of the AVLN that do not support extended beacon period/PPR may monitor beacon slots of other AVLN and, upon detecting a PPI, mark the PPR as a stayout region for their monitored AVLN.

In some embodiments, a low data rate, delay intolerant application running on a node in an AVLN that supports extended beacon period/PPR may have an empty transmission queue that causes the node not to transmit the PPS during the PPR, and yet may shortly thereafter acquire a packet that requires transmission in the beacon period. In these embodiments, the managing node of the AVLN may be adapted to discover such application, decline to transmit PPI while such application is running and mark any PPR as a stayout region for its AVLN. Alternatively, the managing node may allocate a timeslot in the reserved region for the required transmission.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A method performed by a managed node in a powerline network having multiple logical networks, comprising the steps of:
monitoring for a packet presence symbol (PPS) in a packet presence region (PPR) of a beacon period; and
regulating monitoring of a shared carrier sense multiple access (CSMA) region of the beacon period by the managed node based on whether the PPS is detected.

2. The method of claim 1, wherein the PPR is part of an extended beacon region that precedes the shared CSMA region.

3. The method of claim 1, wherein the monitoring step comprises monitoring for the PPS in a PPS slot assigned to a logical network to which the managed node belongs.

4. The method of claim 1, further comprising the step of detecting a PPR presence indicator (PPI) in a beacon region of the beacon period prior to the monitoring step.

5. The method of claim 4, wherein the detecting step comprises detecting the PPI in a beacon slot assigned to a logical network to which the managed node belongs.

6. The method of claim 1, further comprising the step of transmitting the PPS in the PPR.

7. The method of claim 1, wherein the regulating monitoring step comprises monitoring the shared CSMA region by the managed node in response to detecting the PPS.

8. The method of claim 1, wherein the regulating monitoring step comprises inhibiting monitoring of the shared CSMA region by the managed node in response to failing to detect the PPS.

9. The method of claim 1, wherein the method is individually performed by a plurality of managed nodes that belong to a common logical network.

10. A method performed by a managing node in a powerline network having multiple logical networks, comprising the steps of:
monitoring for a PPS in a plurality of PPS slots assigned to a respective plurality of logical networks in a PPR of a beacon period; and
regulating monitoring of a shared CSMA region of the beacon period by the managing node based on whether the PPS is detected in at least one of the PPS slots.

11. The method of claim 10, further comprising the step of transmitting a PPI in a beacon region of the beacon period prior to the monitoring step.

12. The method of claim 11, wherein the transmitting step comprises transmitting the PPI in a beacon slot assigned to a logical network to which the managing node belongs.

13. The method of claim 10, wherein the method further comprises the step of transmitting the PPS in a PPS slot assigned to a logical network to which the managing node belongs.

14. The method of claim 10, wherein the regulating monitoring step comprises monitoring the shared CSMA region by the managing node in response to detecting the PPS within at least one of the PPS slots.

15. The method of claim 10, wherein the regulating monitoring step comprises inhibiting monitoring of the shared CSMA region by the managing node in response to failing to detect the PPS within any of the PPS slots.

16. The method of claim 15, wherein inhibiting monitoring comprises eliminating the shared CSMA region.

17. The method of claim 10, wherein the method is individually performed by a plurality of managing nodes that belong to a respective plurality of logical networks.

18. A powerline network, comprising:
a managing node that belongs to a logical network;
a managed node that belongs to the logical network; and
a channel that communicatively couples the managing node and the managed node, wherein the managed node monitors for a PPS in a PPS slot assigned to the logical network in a PPR of a beacon period and regulates monitoring of a shared CSMA region of the beacon period by the managed node based on whether the PPS is detected, and wherein the managing node monitors for the PPS in a plurality of PPS slots assigned to a respective plurality of logical networks in the PPR and regulates monitoring of the shared CSMA region by the managing node based on whether the PPS is detected within at least one of the PPS slots.

19. The network of claim 18, wherein the managing node transmits a PPI in a beacon region of the beacon period and the managed node detects the PPI.
